(19) United States
(12) Patent Application Publication
(10) Pub. No.: US 2013/0256107 A1
(43) Pub. Date: Oct. 3, 2013

(54) BUTTON MECHANISM AND ELECTRONIC DEVICE USING THE SAME

(71) Applicants: XUE-DONG TANG, Shenzhen City (CN); WEI LIU, Shenzhen City (CN)

(72) Inventors: XUE-DONG TANG, Shenzhen City (CN); WEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/480,485

(22) Filed: May 25, 2012

(30) Foreign Application Priority Data
Apr. 2, 2012 (CN) 201210095535.2

(51) Int. Cl. H01H 13/76; H01H 21/28

(52) U.S. Cl. 200/5 A; 200/343

(57) ABSTRACT

A button mechanism is arranged in an electronic device for actuating a switch. The button mechanism includes a support fixed in the electronic device, a button for receiving an external press to move towards and actuate the switch, and an elastic connection member connecting the button to the support, wherein the elastic connection member is elastically deformed when the button is depressed. The button mechanism further includes a resisting member. The resisting member includes a first end fixed in the button, and a second, suspended end for resisting against a stopping member fixed in the electronic device, wherein when the button moves a predetermined distance towards the switch, the second end resists against the stopping member to prevent the button from further moving towards the switch.

### BACKGROUND

1. Technical Field

The present disclosure relates to electronic devices and, particularly to a button mechanism and an electronic device using the button mechanism.

2. Description of Related Art

Many electronic devices, such as televisions and VCD/DVD players, include a number of physical buttons that can be pressed by users to actuate corresponding switches to activate various functions, such as selecting menu items, turning on/off the device, adjusting volume, and the like. However, it is not uncommon for the corresponding switches to break if the corresponding button is pressed too hard.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is a schematic view showing a part of an electronic device arranged with a number of button mechanisms, in accordance with an exemplary embodiment.

FIG. 2 is similar to FIG. 1, but viewed from another viewpoint.

### DETAILED DESCRIPTION

The disclosure is illustrated by way of example and not by way of limitation. It should be noted that references to “an” or “one” embodiment in this disclosure are not necessarily to the same embodiment, and such references mean at least one.

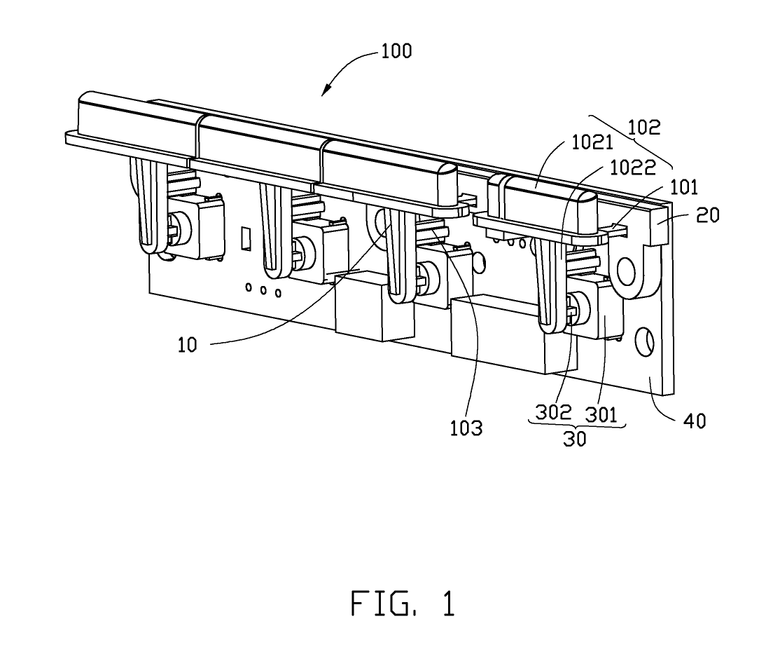

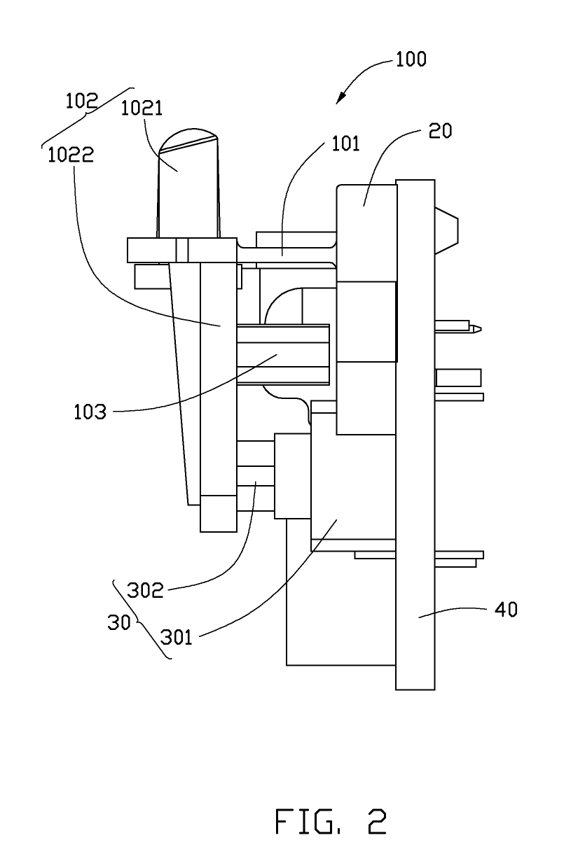

FIGS. 1 and 2 show an electronic device 100 including a main body 40 and at least one button mechanism 10. Each button mechanism 10 is used to receive an external pressure (to be pressed by a user) to actuate a corresponding switch 30 which is fixed to the main body 40. The device 100 may be a television, a VCD/DVD player, or the like. The button mechanism 10 may be a power button or other function selection button. In this embodiment, the electronic device 100 includes four button mechanisms 10. The switch 30 includes a case 301 fixed to the main body 40 and a switch portion 302 protruding from the case 301. When the switch portion 302 is pressed, the switch 30 is actuated.

Each button mechanism 10 includes an elastic connection member 101, a button 102, a resisting member 103, and a support 20. The support 20 is fixed to the main body 40 of the electronic device 100 and near a switch 30 corresponding to the button mechanism 10 in the electronic device 100. In this embodiment, the support 20 has a planar structure.

The elastic connection member 101 connects the button 102 to the support 20. When the button 102 is depressed, the elastic connection member 101 elastically deforms. When the button 102 is released, the elastic connection member 101 rebounds back to its initial position. In this embodiment, the elastic connection member 101 is an elastic tab. Two ends of the elastic tab are respectively perpendicularly connected to the button 102 and the support 20.

The button 102 includes a button body 1021 for being pressed and an actuating portion 1022 protruding from a bottom of the button body 1021. The button body 1021 of the button 102 is elastically connected to the support 20 by the elastic connection member 101. The actuating portion 1022 is connected to the switch portion 302 of the switch 30 and can move down a limited distance to push the switch portion 302 for actuating the switch 30. The button body 1021 and the actuating portion 1022 may be integrally formed.

One end of the resisting member 103 is fixed to the button 102, and the other end of the resisting member 103 is suspended, for resisting against a stopping member 301 fixed in the electronic device 100 to limit movement of the button body 1021 (also the actuating portion 1022) to a desired range. That is, when the button body 1021 moves a predetermined distance towards the switch 30, the resisting member 103 will resist against the stopping member 301 (in this embodiment, the stopping member 301 is the case 301 of the switch 301). Further movement of the button body 1021 (also the actuation portion 1022) is stopped, which protects the switch 30 from being damaged due to overpressure from the actuating portion 1022. In this embodiment, the resisting member 103 perpendicularly protrudes from the actuating portion 1022.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A button mechanism for being arranged in an electronic device for actuating a switch, the button mechanism comprising:
a support fixed in the electronic device;
a button to receive an external press to actuate the switch;
an elastic connection member connecting the button to the support, the elastic connection member being elastically deformed when the button is depressed; and
a resisting member comprising a first end fixed to the button, and a second, suspended end for resisting against a stopping member fixed in the electronic device, wherein when the button moves a predetermined distance towards the switch, the second, suspended end of the resisting member resists against the stopping member to prevent the button from further moving towards the switch.

2. The button mechanism as described in claim 1, wherein the elastic connection member is an elastic tab, and two ends of the elastic tab are respectively perpendicularly connected to the button and the main body.

3. The button mechanism as described in claim 1, wherein the switch comprises a case and a switch portion protruding from the case, the button is connected to the switch portion to actuate the switch, and the case is the stopping member.

4. The button mechanism as described in claim 3, wherein the resisting member perpendicularly protrudes from the button.

5. An electronic device comprising:
a main body; and
at least one button mechanism, each button mechanism being for actuating a corresponding switch and comprising:
a support fixed to the main body;
a button to receive an external press to actuate the switch;
an elastic connection member connecting the button to the support, the elastic connection member being elastically deformed when the button is depressed; and
a resisting member comprising a first end fixed to the button, and a second, suspended end for resisting against a stopping member fixed in the electronic device, wherein when the button moves a predetermined distance towards the switch, the second ,suspended end of the resisting member resists against the stopping member to prevent the button from further moving towards the switch.

6. The electronic device as described in claim 5, wherein the elastic connection member is an elastic tab, and two ends of the elastic tab are respectively perpendicularly connected to the button and the main body.

7. The electronic device as described in claim 6, wherein the switch comprises a case and a switch portion protruding from the case, the button is connected to the switch portion to actuate the switch, and the case is the stopping member.

8. The electronic device as described in claim 7, wherein the resisting member perpendicularly protrudes from the button.
